(19) United States
(12) Patent Application Publication
(10) Pub. No.: US 2024/0075782 A1
(43) Pub. Date: Mar. 7, 2024

(54) SUSPENSION STOP AND SUSPENSION STRUT

(71) Applicant: NTN EUROPE, Annecy (FR)

(72) Inventors: Aurélien BONNAUDET, Annecy (FR); Cyril PETERSCHMITT, La Balme-de-Sillingy (FR)

(73) Assignee: NTN EUROPE, Annecy (FR)

(21) Appl. No.: 18/460,805

(22) Filed: Sep. 5, 2023

(30) Foreign Application Priority Data
Sep. 6, 2022 (FR) 2208909

(51) Int. Cl. B60G 15/06

(52) U.S. Cl. CPC B60G 15/062; B60G 2202/312; B60G 2204/1242; B60G 2204/418; B60G 2206/7101; B60G 2206/7104

(57) ABSTRACT

A suspension strut includes a telescopic damper, a coil spring and a suspension stop. The rotation of the suspension stop is provided by a bearing including at least one single-piece upper washer and a single-piece lower washer, the upper washer forming a planar annular bearing surface for a rod of the telescopic damper. The interface between the coiled spring and the bearing is provided by a single-piece cup including a body forming a peripheral annular zone for housing an upper end of the coiled spring. The single-piece cup includes an anti-wear coating having a thickness of less than 2 mm, overmolded on the body and at least partially covering the peripheral annular zone housing zone in order to be interposed between the body of the single-piece cup and the upper end of the coil spring.

### CROSS-REFERENCE TO RELATED APPLICATIONS

This application claims the benefit of priority under 35 U.S.C. 119 to French Patent Application No. 2208909, filed Sep. 6, 2022; the disclosure of which is incorporated herein by reference in its entirety.

### TECHNICAL FIELD OF THE INVENTION

The invention relates to the field of suspensions of land vehicles, in particular of motor vehicles, and targets a suspension stop for a suspension strut comprising a coil spring. The invention also relates to a suspension strut comprising such a stop.

### PRIOR ART

In document EP3219521A1, a suspension strut is illustrated comprising a coil spring, a telescopic damper located inside the coil spring, and a suspension stop comprising: a sliding or rolling bearing and a single-piece cup intended to be interposed between the rolling bearing and the coil spring. The bearing comprises at least one metal upper washer and a metal lower washer guided in rotation relative to each other about a reference axis of the suspension stop, the upper washer forming a planar annular bearing surface for a rod of the telescopic damper. The single-piece cup comprises a body made of plastic or composite material having an upper face forming a contact zone with the lower washer and an upper face forming an external planar annular shoulder and an at least partially cylindrical annular bearing surface facing radially outwards and delimiting with the external shoulder a peripheral annular zone for housing the upper end of the coil spring. The single-piece cup, preferably made of a moldable material, in particular made of plastic material possibly loaded, or made of a composite material with or without metal insert, constitutes itself the interface between the lower washer of the bearing and the coil spring.

This suspension stop proves particularly compact in the axial direction, which allows it to meet compactness requirements imposed by the vehicle manufacturer. In use, in certain corrosion resistance test conditions, it may however be observed that a breakage of the spring is attributed to wear of the anti-corrosion coating of the spring at the interface between the coil spring and the peripheral annular housing zone.

For a suspension strut of substantially less compact design, shown in document FR2964435A1, it is proposed to interpose, between the coil spring and the peripheral annular housing zone, a ring made of elastomeric material intended to filter the vibrations of the coil spring. Such a ring necessarily has a

large thickness to perform its filtering function, which makes it incompatible with a compact structure.

US2021010538 discloses a suspension thrust bearing device for use with a suspension spring in an automotive suspension strut of a vehicle, which includes a bearing having an upper annular bearing member and a lower annular bearing member configured for relative rotation. The lower annular bearing member includes a radial body and a damper having a radial portion made of resilient material overmolded to a lower side of the radial body. The damper radial portion has a lower support surface configured to axially support an end coil of the suspension spring, and the damper radial portion has a material hardness of 50 to 85 Shore A and an axial thickness of 2 to 10 mm.

### SUMMARY

The invention aims to overcome the disadvantages of the prior art and to propose a suspension stop and a compact suspension strut that is more resistant to corrosion.

To do this, a suspension stop for a suspension strut comprising a coil spring and a telescopic damper is proposed according to a first aspect of the invention. The suspension stop comprises at least one single-piece upper washer and a single-piece lower washer guided in rotation relative to each other about a reference axis of the suspension stop, the upper washer forming a planar annular bearing surface for a rod of the telescopic damper. The suspension stop further comprises a single-piece cup comprising a body having an upper face forming a contact zone with the lower washer and a lower face forming a peripheral annular zone for housing an upper end of the coil spring.

According to the invention, the single-piece cup comprises an anti-wear coating having a thickness of less than 2 mm, overmolded on the body of the single-piece cup and at least partially covering the peripheral annular zone housing zone in order to be interposed between the body of the single-piece cup and the upper end of the coil spring.

The anti-wear coating is intended to limit the wear of the upper end of the coil spring, and thus to preserve the anti-corrosion coating of the coil spring. Its low thickness does not allow it to constitute effective filtration of the spring, but makes it compatible with a very compact assembly.

The anti-wear coating has a hardness greater than 85 Shore A, preferably greater than or equal to 90 Shore A.

The washers are preferably metallic.

According to one embodiment, the peripheral annular housing zone comprises an outer planar annular shoulder, and where appropriate an annular bearing surface, preferably at least partially cylindrical or frustoconical, turned radially outwards, the covering preferably covering at least the outer planar annular shoulder. The area of greater stress on the spring is thus covered.

Preferably, the coating is made of thermoplastic polyurethane. The thermoplastic polyurethane (TPU) is selected here for its excellent mechanical properties of abrasion and tear resistance. Preferably, the TPU may be a polyester TPU or a polyether TPU.

According to one embodiment, the body of the single-piece cup is made of moldable material, preferably of plastic or composite material, loaded or not with fibers, in particular glass fibers, and preferably PA6 GF60. If necessary, the single-piece cup comprises a reinforcing insert, preferably a metal insert. Preferably, the single-piece cup is molded, preferably by injection. The overmolding of the anti-wear coating can be carried out in the injection mold of the body of the single-piece cup, by co-injection. Preferably, the molding of the single-piece cup is carried out in a mold with a purely axial movement. In other words, the shapes are chosen to avoid a side-slider mold, in order to increase production rates and to limit the complexity and costs.

According to one embodiment, the lower washer has an outer diameter that is less than an inner diameter of the peripheral annular zone for housing the upper end of the coil spring.

According to one embodiment, the planar annular bearing surface projects distally towards the interior relative to the lower washer.

According to one embodiment, the bearing is a rolling bearing, comprising rolling bodies in contact with raceways formed on the upper and lower washers. Alternatively, the bearing may be a sliding bearing, with or without a friction washer interposed between the upper washer and the lower washer.

According to one embodiment, the upper washer is bearing directly or indirectly on a filter block intended to be interposed between the upper washer and a body element of a motor vehicle. The filter block is intended for filtering the movements of the rod of the damper, as well as the filtration of the vibrations of the spring transmitted via the single-piece cup, and of the bearing.

Provision may also be made for a cover that bears against the upper washer, and where appropriate interposed between the upper washer and the filter block. This cover may have a peripheral skirt forming with a peripheral relief of the upper face of the single-piece cup a labyrinth seal. The cover may advantageously be clipped onto the single-piece cup, the peripheral skirt and the peripheral relief being able to present mutual snap-fastening zones for this purpose, which makes it possible to form a coherent subassembly between the rolling bearing and the cup, before it is mounted on the vehicle.

According to another aspect of the invention, the invention relates to a suspension strut comprising a coil spring, a telescopic damper and a suspension stop as described above, the coil spring having an upper bearing end housed in the peripheral housing zone bearing against the anti-wear coating, the telescopic damper passing through the suspension stop and bearing against the planar annular bearing surface formed by the upper washer.

### BRIEF DESCRIPTION OF THE FIGURES

Other features and advantages of the invention will become apparent on reading the following description, with reference to the appended figures, which show:

FIG. 1 shows a cross-sectional view of a suspension strut and a suspension stop according to a first embodiment of the invention;

FIG. 2 shows a cross-sectional view of a cup of a suspension stop according to an alternative embodiment.

For greater clarity, identical elements are identified by identical reference signs in all of the Figures.

### DETAILED DESCRIPTION

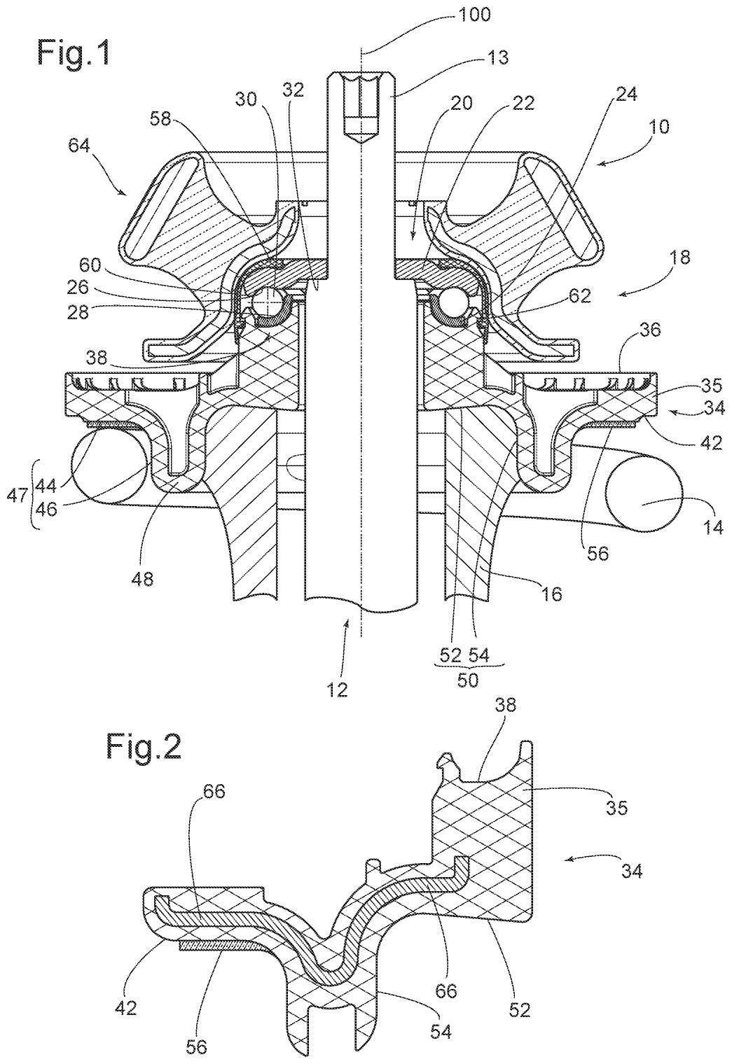

Referring to FIG. 1, a suspension strut 10 is composed, in its upper part, of a telescopic damper 12 of which only the head 13 has been shown, of a coil spring 14, if applicable a shock pad 16 and a rotating suspension stop 18 ensuring the interface between the preceding elements and the body of the vehicle (not shown).

The rotation of the suspension stop 18 about a reference axis 100 is provided by a rotational guide bearing 20, here a rolling bearing comprising an upper longitudinal washer 22 and a metal lower washer 24, preferably made by crimping a sheet, and defining raceways 26, 28 on which rolling bodies roll 30, in this case, balls. The upper washer 22 forming a planar annular bearing surface 32 for the rod 13 of the telescopic damper 12, extending radially inward relative to the raceways 26, 28.

The interface between the rolling bearing 20 on one hand and the telescopic damper 12, coil spring 14, and if applicable shock pad 16 on the other hand is provided by a single-piece bearing cup 34, whose body 35 is made of moldable material, preferably of plastic, charged or not, or composite.

The body 35 has on its upper face 36 a contact zone 38 with the lower washer 24 of the rolling bearing 20. The underside 42 of the cup 34 present at its periphery an outer plane annular shoulder 44 and an at least partially cylindrical annular bearing surface 46 facing radially outwards and delimiting with the external shoulder 44 a peripheral annular housing zone 47 of an upper end of the coil spring 14.

The body 35 of the cup 34 preferably has a partition forming an annular fold 48 forming the annular bearing surface 46 and externally surrounding a zone 50 for housing an upper end of the shock pad formed by a planar annular shoulder 52 and by an at least partially cylindrical containment face 54 facing radially inwards. The containment face 54 the zone 50 for housing the upper end of the shock pad 16 is located radially inside the annular bearing surface 46 of the peripheral zone for housing the upper end of the spring 14. The lower washer 24 has a diameter smaller than the diameter of the cylindrical bearing 46 and preferably smaller than the diameter of the containment face 54.

Remarkably, the cup 34 further comprises an anti-wear coating 56 made of TPU having a thickness of less than 2 mm, overmolded on the plastic or composite body 35 and at least partially covering the peripheral annular housing zone 47 to be interposed between the body 35 of the single-piece cup 34 and the upper end of the coil spring 14. The anti-wear coating 56 preferably covering at least the outer planar annular shoulder 44 of the peripheral annular housing zone 47.

A protective cover 58 of the rolling bearing 20 bears against the upper washer 22 and has a peripheral skirt 60 forming with a peripheral relief or lugs 62 of the upper face 36 of the cup 34 a seal with or without contact. The peripheral skirt 60 and the peripheral relief 62 have mutual snap-fastening zones that are not engaged after the suspension stop is installed on the vehicle, but make it possible to constitute a coherent subassembly that is preassembled between the rolling bearing 20 and the cup 34 before being mounted on the vehicle.

Vibratory and sound insulation between the suspension strut 10 and the vehicle body is provided by a filter block 64 bearing against the protective cover 58, or if applicable directly on the upper washer 22, and which takes up all the efforts and all the vibrations passing through the upper washer 22, that they travel through the coil spring 14 and the cup 34 or through the rod 13 of the damper 12.

The cup 34 shown in FIG. 2 is distinguished from that of FIG. 1 by the presence of a reinforcing insert 66, preferably metal overmolded by the body 35.

According to another embodiment not shown, the bearing 20 may be a sliding bearing, the upper washer 22 and the lower washer 24 having annular friction tracks in contact with each other. It is also possible to envisage a sliding bearing with a friction washer interposed between the upper washer 22 and the lower washer 24.

Other variants are naturally possible, in particular by combining features of the different embodiments between them.

1. A suspension stop for a suspension strut comprising a coil spring and a telescopic damper, the suspension stop comprising:
a bearing comprising a single-piece upper washer and a single-piece lower washer guided in rotation relative to each other about a reference axis of the suspension stop, the upper washer forming a planar annular bearing surface for a rod of the telescopic damper; and
a single-piece cup having a body having an upper face forming a contact zone with the lower washer and lower face forming a peripheral annular housing zone for housing an upper end of the coil spring;
wherein the single-piece cup comprises an anti-wear coating having a thickness of less than 2 mm, overmolded on the body of the single-piece cup and at least partially covering the peripheral annular housing zone in order to be interposed between the body of the single-piece cup and the upper end of the coil spring.

2. The suspension stop of claim 1, wherein the peripheral annular housing zone comprises an outer planar annular shoulder.

3. The suspension stop of claim 2, wherein the peripheral annular housing zone comprises an annular bearing surface facing radially outwards.

4. The suspension stop of claim 3, wherein the covering covers at least the outer planar annular shoulder.

5. The suspension stop of claim 1, wherein the coating is made of thermoplastic polyurethane.

6. The suspension stop of claim 1, wherein the body of the single-piece cup is made of a moldable material.

7. The suspension stop of claim 1, wherein the body of the single-piece cup is made of a plastic.

8. The suspension stop of claim 1, wherein the body of the single-piece cup is made of a composite material, charged or not with fibers.

9. The suspension stop of claim 1, wherein the body of the single-piece cup is made of a composite material charged with glass fibers.

10. The suspension stop of claim 1, wherein the single-piece cup comprises a reinforcing insert.

11. The suspension stop of claim 10, wherein the reinforcing insert is a metal insert.

12. The suspension stop of claim 1, wherein the lower washer has an outside diameter that is less than an inside diameter of the peripheral annular housing zone for housing the upper end of the coil spring.

13. The suspension stop of claim 1, wherein the planar annular bearing surface protrudes distally towards an interior relative to the lower washer.

14. The suspension stop of claim 1, wherein the bearing is a rolling bearing, comprising rolling bodies in contact with raceways formed on the upper and lower washers.

15. The suspension stop of any of claim 1, wherein the bearing is a sliding bearing, with or without a friction washer interposed between the upper washer and the lower washer.

16. The suspension stop of claim 1, wherein the upper washer bears directly or indirectly on a filter block intended to be interposed between the upper washer and a body element of a motor vehicle.

17. The suspension stop of claim 16, wherein the upper washer bears on a protective cover which bears on the filter block.

18. The suspension stop of claim 1, wherein the anti-wear coating has a hardness greater than 85 Shore A.

19. A suspension strut comprising a coil spring, a telescopic damper and a suspension stop comprising a coil spring and a telescopic damper, the suspension stop comprising:
a bearing comprising a single-piece upper washer and a single-piece lower washer guided in rotation relative to each other about a reference axis of the suspension stop, the upper washer forming a planar annular bearing surface; and
a single-piece cup having a body having an upper face forming a contact zone with the lower washer and lower face forming a peripheral annular housing zone;
wherein the single-piece cup comprises an anti-wear coating having a thickness of less than 2 mm, overmolded on the body of the single-piece cup and at least partially covering the peripheral annular housing zone,
the coil spring has an upper bearing end housed in the peripheral annular housing zone bearing against the anti-wear coating, and
the telescopic damper passes through the suspension stop and bears against the planar annular bearing surface formed by the upper washer.

20. A suspension strut for a motor vehicle, the suspension strut comprising a coil spring, a telescopic damper and a suspension stop comprising a coil spring and a telescopic damper, the suspension stop comprising:
a bearing comprising a single-piece upper washer and a single-piece lower washer guided in rotation relative to each other about a reference axis of the suspension stop, the upper washer forming a planar annular bearing surface; and
a single-piece cup having a body having an upper face forming a contact zone with the lower washer and lower face forming a peripheral annular housing zone;
a filter block against which the upper washer bears directly or indirectly, and intended to be interposed between the upper washer and a body element of the motor vehicle,
wherein the single-piece cup comprises an anti-wear coating having a thickness of less than 2 mm, overmolded on the body of the single-piece cup and at least partially covering the peripheral annular housing zone,
the coil spring has an upper bearing end housed in the peripheral annular housing zone bearing against the anti-wear coating, and
the telescopic damper passes through the suspension stop and bears against the planar annular bearing surface formed by the upper washer.
